(19) United States
(12) Patent Application Publication
(10) Pub. No.: US 2007/0143306 A1
(43) Pub. Date: Jun. 21, 2007

(54) Integrated website management system and management method thereof

(76) Inventor: Jae-Hyuk Yang, Seoul (KR)

Correspondence Address: HARNESS, DICKEY & PIERCE, P.L.C., P.O. BOX 828, BLOOMFIELD HILLS, MI, 48303, US

(21) Appl. No.: 11/636,721

(22) Filed: Dec. 8, 2006

(30) Foreign Application Priority Data
Dec. 15, 2005 (KR) 2005-123557

(51) Int. Cl. G06F 17/30

(52) U.S. Cl. 707/10

(57) ABSTRACT

The present invention relates to an integrated website management system and a management method thereof, and more specifically, to an integrated website management system and a management method thereof, in which log information on the visitors to the website and a result of searching thereof are display on a single screen so that the log information can be clearly analyzed, and contents data of a webpage can be updated in real-time using the web log analysis information and the search result. According to the present invention, when web log analysis data or search result analysis data is created, it is sent to a manager or an operator who works separately, and a programmer or a web designer does not need to update the website. All analyses and updates are performed in a single tool, and thus a prompt response can be made.

### BACKGROUND OF THE INVENTION

1. Field of the Invention

The present invention relates to an integrated website management system and a management method thereof, and more particularly, to an integrated website management system and a management method thereof, in which log information on the visitors to the website and a result of searching thereof are display on a single screen so that the log information can be clearly analyzed, and contents data of a webpage can be updated in real-time using the web log analysis information and the search result.

2. Background of the Related Art

If an Internet user visits a website on the Internet, information such as a visitor's Internet protocol (IP) address, the number of connections to the website, or the like is automatically stored in a corresponding web server, which is called as log information.

A website operator analyzes such log information in order to grasp behaviors or the like of the visitors shown in the web server from the number of visitors to the website and visitors' interests, and uses the log information as important materials for efficiently managing the website.

Generally, for the purpose of history management or the like accompanied by using a website, log information (materials having recorded therein what the website has processed or the state of using the website along the time axis) provided by a web server is extracted and analyzed using a log analyzer, and information on the state of using the website is extracted and stored in a database. Such web log extraction and analysis are techniques needed for analyzing the members of each website and information inputted by users so that improved web services can be provided.

Internet portal sites or electronic commerce sites use various kinds of web log analysis software in order to clearly measure how many users have visited their websites, how many users among the visitors are visitors pure intention, paths through which they have visited the websites, or the like.

Web log analysis is used to grasp characteristics and behavioral patterns of users visiting a specific website, and properly provide services satisfying customers' desires through customer relationship management (CRM) services.

That is, it is moving the locations of web pages or contents that are currently requested a great deal by users to a position further frequently exposed or changing the design of the contents or the like to provide the contents to the users further efficiently.

However, in such a conventional technique, since web log analysis and search result analysis are separately performed and update of contents based on such analysis information is also performed by a separate program, it is inconvenience that there should be employed a manager who separately performs the log analysis and the contents update.

In addition, since a result of a web log analysis or search is not transferred to a contents management system, it is inconvenient in that contents are managed not efficiently.

### SUMMARY OF THE INVENTION

Therefore, the present invention has been made in view of the above problems occurring in the prior art, and it is an object of the present invention to provide an integrated website management system and a management method thereof, in which a dashboard that can collectively perform web log analysis, search, and contents management is created, and all the operations are performed together within the dashboard.

To accomplish the above object, according to one aspect of the present invention, there is provided an integrated website management system for analyzing log information on website visitors and managing the website, comprising a control unit; a web log analyzing unit for creating web log analysis information by analyzing a web log containing access particulars to a service page or contents displayed on the website if a user terminal connected to the website through the Internet views the service page or the contents, and displaying the web log analysis information on the user terminal; a search engine for performing a search for keywords inputted from the user terminal, creating a search result matching to the keywords, and displaying the created search result on the user terminal; a contents management unit for creating and storing contents data for the contents included in the service page of the website and displayed on the user terminal, and updating and storing the location, order, and attributes of the contents; and a contents information DB for storing the contents data.

Preferably, the integrated website management system of the present invention further comprises: a template management unit for selecting a specific design template among a plurality of design templates created appropriately to the characteristics of a website or a user, creating a report screen by inserting the web log analysis information and the search result into the selected design template, and transmitting and displaying the report screen on the user terminal.

The control unit transmits the web log analysis information created by the web log analyzing unit and the search result created by the search engine to the contents management unit, creates a dashboard for displaying the web log analysis information and the search result so as to collectively view the web log analysis information and the search result, and displays the created dashboard on the user terminal.

The web log analyzing unit extracts and analyzes the scripts inserted in the service page or the contents, and creates the web log analysis information for the service page or the contents.

According to another embodiment of the present invention, there is provided a website management method for analyzing log information on website visitors and updating contents of a service page based on the analysis information using the integrated website management system, comprising the steps of: creating and storing contents data for the contents displayed in the service page, creating web log analysis information by analyzing a web log containing access particulars to the service page or the contents displayed on the website if a user terminal connected to the website through the Internet views the service page or the contents, performing a search for keywords inputted from the user terminal and creating a search result matching to the keywords, transmitting and displaying the web log analysis information and the search created result on the user terminal, and updating and storing the location, order, and attributes of the contents based on the web log analysis information and the search result.

The step of displaying the web log analysis information and the search result comprises the steps of: creating and storing design templates configured appropriately to the characteristics of the website or a user; selecting a specific design template among the design templates and creating a report screen by inserting the web log analysis information and the search result into the selected template; and transmitting and displaying the report screen on the user terminal.

The report screen is outputted on a dashboard where the web log analysis information and the search result are collectively displayed.

The step of creating web log analysis information extracts and analyzes the scripts inserted in the service page or the contents, and creates the web log analysis information for the service page or the contents.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a block diagram showing the configuration of a management system according to an embodiment of the present invention;

FIG. 2 is a block diagram showing the configuration of a dashboard for collectively viewing a website;

FIG. 3 is a flowchart illustrating the steps of an integrated management method using the management system;

FIG. 4 is an exemplary view showing a web log analysis screen of the dashboard;

FIG. 5 is a table showing essential report elements based on a web log;

FIG. 6 is an exemplary view showing a method of changing the configuration of the web log analysis screen;

FIG. 7 is an exemplary view showing a contents management screen displayed by a contents management unit; and

FIG. 8 is an exemplary view showing a method of updating the contents.

### DETAILED DESCRIPTION OF THE PREFERRED EMBODIMENT

Hereinafter, the integrated management system (hereinafter, referred to as a “management system”) of a website according to an embodiment of the present invention will be described with reference to the accompanying drawings.

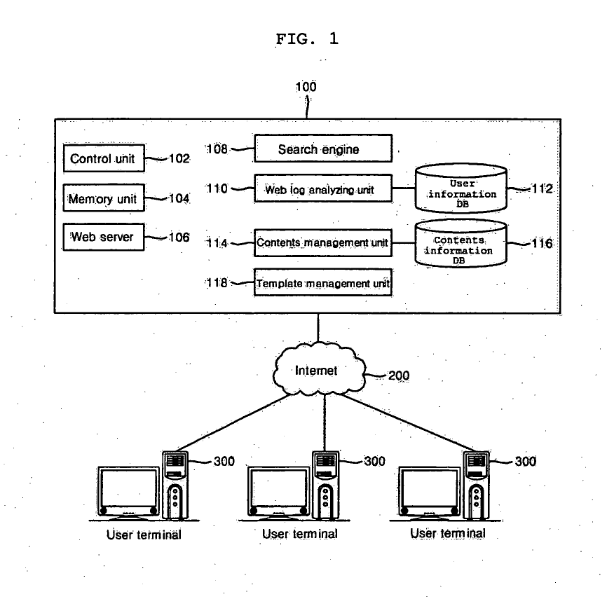

FIG. 1 is a block diagram showing the configuration of the management system according to an embodiment of the present invention.

Referring to FIG. 1, the management system 100 is connected to a plurality of user terminals 300 through the Internet 200. The management system 100 is described to be included in an enterprise's website system that provides search services or web contents. However, apart from the website system, the management system can be set up as an independent system that only takes charge of web log analysis or contents update.

The management system 100 basically comprises a control unit 102, a memory unit 104, and a web server 106.

The control unit 102 and the memory unit 104 perform basic operations needed for operating the management system 100 and exchanging data with the user terminals 300, the configuration of which is well-known that it will not be described in detail.

The web server 106 transmits a variety of data or contents to the user terminal 300 and provides a browser for exchanging data with the user terminal 300.

A search engine 108 searches a result matching to the keywords inputted from the user terminal 300 and displays from the most closely related result. Recently, disclosed are techniques, in which if keywords to be used as search words are inputted, similar keywords related thereto are displayed together with the keywords to broaden the range of search, and this method can be used together.

If a user inputs keywords and searches contents after visiting a specific website, the inputted keywords and search log information on the searched contents are recorded in the web server 106. If the search log information is extracted, details of customer's preference, interests, desired information, and the like can be correctly analyzed. Services considering user's convenience, such as a search result report, recommended search, synonym search, or the like, can be provided based thereon. Based on the search log information, customer's issues are identified, and services according thereto, such as reconfiguring the website or the like, can be implemented.

In addition, the documents displayed as a search result preferably support searching the main contents of various types of document files (for example, Hangul files, MS-Word, Excel, PDF, etc.), as well as hypertext markup language (HTML) web documents.

A web log analyzing unit 110 analyzes access particulars, traveling details, and the like of the user terminals 300 who have visited the website managed by the management system 100, and grasps user's characteristics and requirements of the user terminal 300.

For this purpose, the web log analyzing unit 110 creates purified log analysis information by extracting and analyzing scripts for log analysis inserted in the contents and a service page to be analyzed. A log analysis result created as such can be transmitted to a contents management unit 114 and used for managing the contents of the website.

The scripts for log analysis are program codes inserted in a service page for the management system 100 to collect and analyze web log information, which are recorded when various forms of contents are inserted into formalized design templates. The records of the user terminal 300 connecting to the web site and viewing a service page or web contents are remained in the web server 106. At this point, the scripts inserted in the corresponding service page are recorded at the same time, and thus it can be correctly traced.

The web log analyzing unit 110 grasps access particulars of the user terminal 300 by extracting and analyzing the scripts from the web log information on the user terminal 300, creates an analysis report by recording the analysis result into a design template, and displays the report on the user screen 300.

The information analyzed by the web log analyzing unit 110 can include a variety of elements, typically such as the number of visitors, average page views per visit, popular pages, reference link pages for visit, popular contents, and the like. Such elements are analyzed in the unit of day or week and stored inside the management system 100.

A user information database (DB) 112 stores personal information of a user who joined the website as a member, together with the connection information of the user, and thus tailored information for each customer can be transferred.

The contents management unit 114 creates and records contents of photographs, moving pictures, writings, or the like provided by web pages and changes display locations or priorities thereof.

That is, it creates and stores contents data of the contents provided by the web pages and displayed on the user terminal, and updates and stores the attributes of the contents (including display location, order, type, and the like of the contents) according to the contents data.

In order to manage the contents of a website, the general manager, web designers, programmers, and the like should work together. Then, the contents popular to users among the contents currently exposed on a web page is arranged at a position that can be further easily exposed, and the other contents are deleted or arranged to have a lower priority.

In a conventional website management system, the log information analyzed by the web log analyzing unit 110 is transferred to the general manager of contents, and the locations, priorities, or attributes of the contents within a web page are changed through a separate work based thereon. This is a work that can be done with an additional application program, and thus it must be very troublesome in the aspect of time and procedures needed for the change.

In the website management system 100 of the present invention, since web log analysis information or a search result are transmitted in connection with the contents management unit 114, the locations, priorities, or attributes of the contents inside a web page can be changed in real-time without using an additional application program.

Further, since an HTML web editor using a WYSIWYG(what you see is what you get) method is used like a word processor, even a non-expert can input texts, input images, set a format, or set a number.

In addition, single contents can be configured and displayed on a plurality of screens using a design template. If design templates are registered by the category of website, all contents included in a corresponding category are automatically reconfigured to a corresponding template and displayed on the website thereafter. Design templates are managed by the version, and a plurality of samples are previously prepared to be used by only changing the contents as needed. The contents are preferably maintained as are even though an individual design is changed. A web designer or programmer can develop and change such design templates.

In other words, the subject that creates contents and the subject that creates templates are separated, and thus a template mostly relevant to user's requirements and resulting materials can be combined and provided to the user.

For every user participating in the creation and management of contents and in the operation of the website, a variety of groups can be created, each being in charge of a site or a category, and the rights corresponding thereto can be granted. An approval rule of a serial or a parallel method can be set up, and a once registered approval rule can be continuously reused for other contents and site categories.

As a method of distributing or allocating contents, an additional deploy engine can be embedded and used to transmit contents further rapidly and stably compared with the existing file transfer protocol (FTP). The deploy engine has a schedule setting function so that the interval and range of distributing the contents can be easily set.

Meanwhile, a contents information DB 116 stores a variety of contents data provided by a website.

A template management unit 118 creates a result report screen by combining a web log analysis result and a search result displayed on the user terminal 300 with a formalized design template, and configures the created report screen on a dashboard and transmits it to the user terminal 300.

The design template combined with the web log analysis result and the search result can be created by the management system 100 or an external system (a web designer or a programmer) as described above, and is previously created and stored appropriately to the characteristics of a website or a user. Accordingly, the template management unit 118 selects the most appropriate design template among a plurality of previously created design templates, creates a report screen by combining the contents of a report transmitted from the search engine 108 or the web log analyzing unit 110 with a specific design template, and transmits the report screen to the user terminal 300.

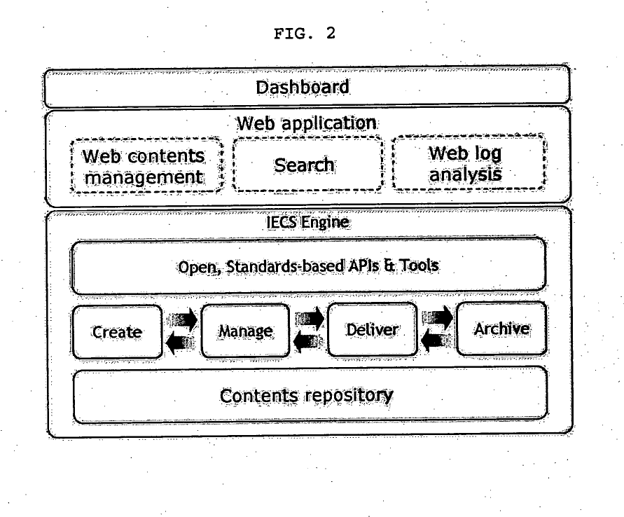

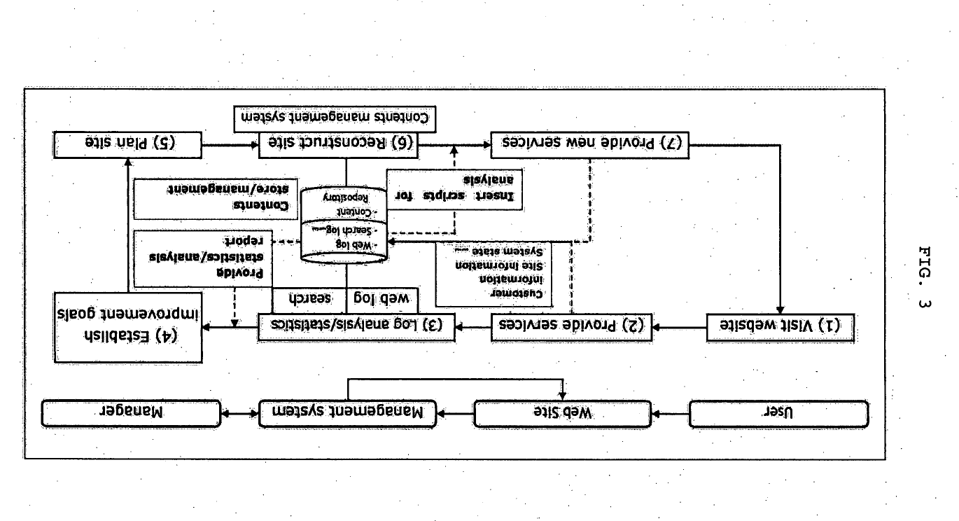

FIG. 2 is a block diagram showing the configuration of a dashboard for collectively viewing a website, and FIG. 3 is a flowchart illustrating the steps of an integrated management method using the management system.

Referring to FIGS. 1 to 3, the dashboard applied to the present invention is designed to monitor a web log analysis result or the like within a single integrated viewer program.

As shown in FIG. 2, since an integrated solution is provided within a single tool (a dashboard), it is advantageous in that an additional solution needs not to be purchased separately to expand the functions. Accordingly, if the present invention is applied, all aspects of a website, from planning to statistics, analysis, site evaluation, and result feedback, can be simultaneously grasped.

In addition, standard application program interfaces (APIs) are provided to connect a variety of applications, and thus it is effective in that the system can be easily expanded.

Specifically, (1) if a user visits a website using the user terminal 300, (2) the website provides a variety of services through searching or providing contents. (3) While such services are provided, the management system 100 creates and analyzes web log information that has access particulars of the user terminal 300, and creates statistics data.

(4) The manager of the website can collectively view a variety of analysis data on the dashboard, understands problems of the website based on the analysis data, establishes improvement goals, and (5) prepares a plan for a new website.

(6) The manager reconstructs the site based on the new plan and changes locations or attributes of contents using a contents management system, (7) thereby providing new services to the user terminals 300. That is, various problems and improvements grasped on the dashboard of the present invention can be easily connected to complementary works for the website in practice.

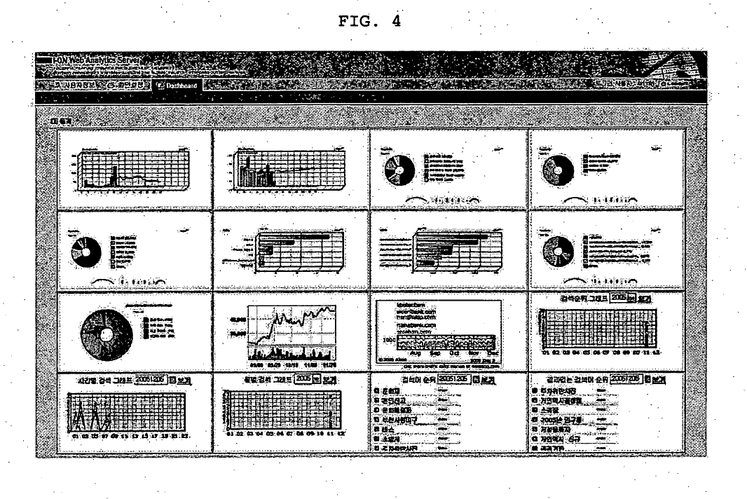

FIG. 4 is an exemplary view showing a web log analysis screen of the dashboard.

As shown in FIG. 4, on the dashboard of an integrated view, a variety of statistics data based on a web log analysis result and a search result is outputted within a single program. Accordingly, the manager can obtain analysis data on his or her website in real-time, and thus can promptly respond thereto.

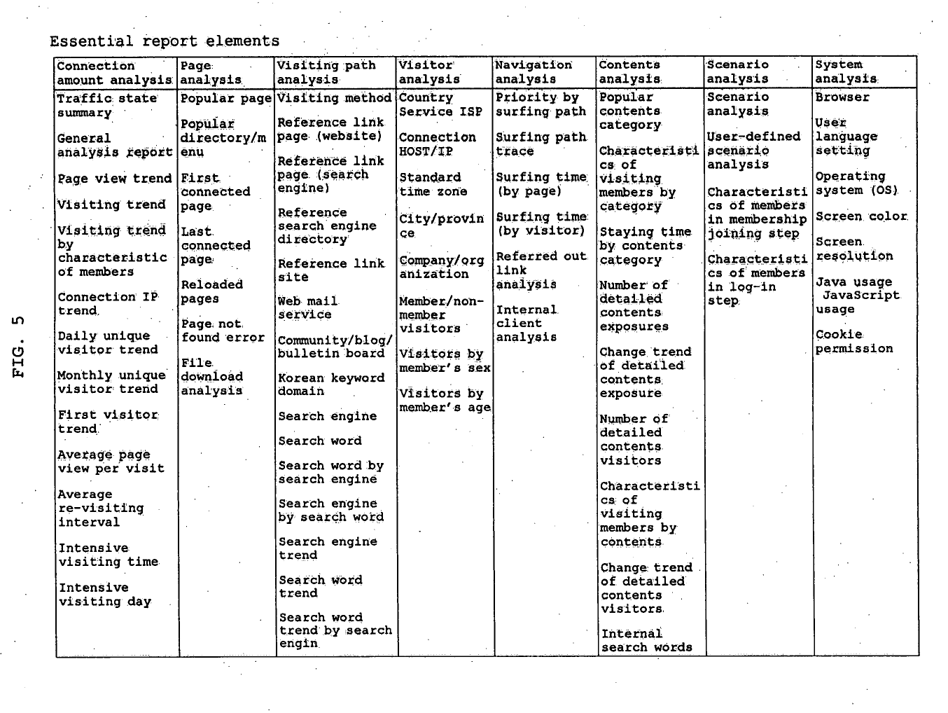

FIG. 5 is a table showing essential report elements based on a web log. The report elements provided to a user comprises categories of connection amount analysis, page analysis, visiting path analysis, visitor analysis, navigation analysis, contents analysis, scenario analysis, system analysis, or the like. However, such categories are nothing but an example of an embodiment, and more elements can be added according to user's requirements, characteristics of a website, or the like.

In addition, contents usage information based on web log information (including member database connection information), search log, and other out-of-site information that a user desires to monitor (stock quotations, site ranking information, or the like) can be displayed on the dashboard.

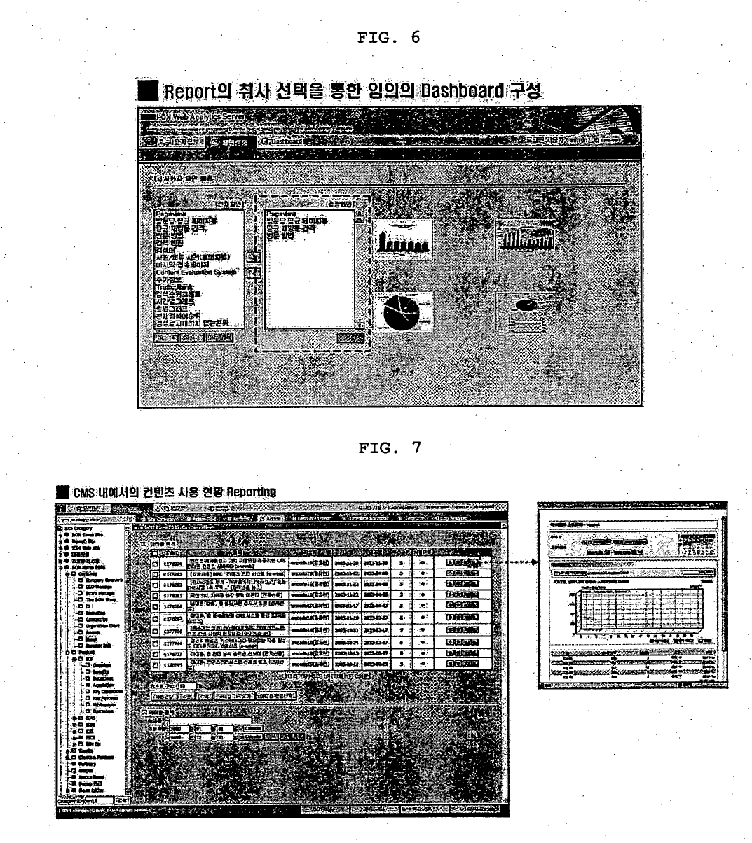

FIG. 6 is an exemplary view showing a method of changing the configuration of the web log analysis screen. A user can arbitrarily determine constitutional elements of a variety of analysis reports displayed on the dashboard. If the user desires to display all the elements of an analysis report provided by the present invention, the user clicks the whole screen button and stores all the elements listed on the left side into the setup screen window. If an element among the elements displayed in the setup screen window does not need to be displayed any more, the element is removed from the setup screen window by clicking the delete button.

When the user changes the constitutional elements of the dashboard, the template management unit 118 changes the size or location of a predetermined template so that all the constitutional elements can be displayed on a single screen. Needless to say, if a large number of constitutional elements are selected, the display screen of an individual report inevitably becomes smaller, and it can be set such that if a corresponding report is selected, further detailed information is displayed in a separate window.

FIG. 7 is an exemplary view showing a contents management screen displayed by a contents management unit, in which provided is an interface that can change the location or attributes of contents based on connection or download statistics data for a variety of contents provided on the website.

When the manager changes or updates the contents of a web page after viewing log analysis information provided by the web log analyzing unit 110, the manager logs into a separate contents management system (CMS) and updates corresponding contents and service pages. Accordingly, in the contents management system, the manager manages contents based on the data confirmed on the dashboard. At this point, a variety of log analysis information displayed on the dashboard is transferred to the contents management system and can be effectively used, and thus it is advantageous in that the time and the process needed for the operation can be reduced and simplified. In addition, since log analysis data or search result data is immediately transmitted, and connection priorities or the like are displayed in real-time based thereon, it is easy to understand how to update or change the contents.

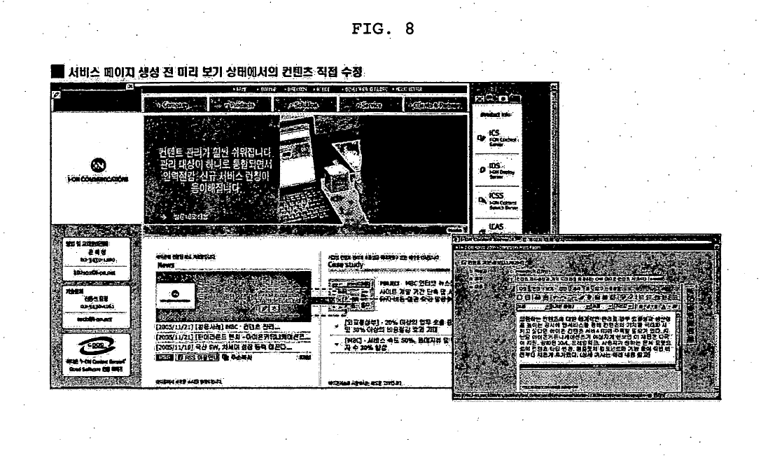

FIG. 8 is an exemplary view showing a method of updating the contents, in which the configuration of a web page can be changed in a WYSIWYG method as described above.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

In the present invention, it is explained that the website operation, log analysis, and content management are performed in a single system. However, it can be embodied such that a website for providing a variety of contents separately exists, and a management system connected through a network analyzes the execution state of the website and provides analysis data. For this purpose, the management authority should be granted so that the management system existing outside the website can change the data and configuration of a web page inside a corresponding website.

According to the present invention, when web log analysis data or search result analysis data is created, it is sent to a manager or an operator who works separately, and a programmer or a web designer does not need to update the website. All analyses and updates are performed in a single tool, and thus a prompt response can be made.

Furthermore, since behaviors of a visitor are immediately reflected to the configuration of a website, only the most appropriate information is selected and provided to a specific user based on the analysis result of the visitor, thereby maximizing marketing effects, which will be a foundation for maximizing return on investment (ROI) of an enterprise in the future.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. An integrated website management system for analyzing log information on website visitors and managing the website, the system comprising:
a control unit;
a web log analyzing unit for creating web log analysis information by analyzing a web log containing access particulars of user terminal to a service page or contents of the website;
a search engine for performing a search for keywords inputted from a user terminal, creating a search result matching to the keywords, and displaying the created search result on the user terminal;
a contents management unit for creating and storing contents data for contents displayed on the user terminal, and updating and storing attributes of the contents based on the contents data; and
a contents information DB for storing the contents data.

2. The system according to claim 1, further comprising:
a template management unit for creating a report screen by inserting the web log analysis information and the search result into a certain design template and displaying the report screen on the user terminal.

3. The system according to claim 1, wherein the control unit transmits the web log analysis information created by the web log analyzing unit and the search result created by the search engine to the contents management unit, creates a dashboard for displaying the web log analysis information and the search result, and displays the created dashboard on the user terminal.

4. The system according to claim 1, wherein the web log analyzing unit extracts and analyzes scripts inserted in the service page or the contents, and creates the web log analysis information for the service page or the contents.

5. A website management method for analyzing log information on website visitors and updating contents of a service page based on an analysis result using the integrated website management system claimed in any one of claims 1 to 4, the method comprising:
a contents data creating/storing step of creating and storing contents data for the contents displayed in the service page;
a web log analyzing/creating step of creating web log analysis information by analyzing a web log containing access particulars of user terminal to the service page or the contents of the website;
a search result creating step of performing a search for keywords inputted from the user terminal and creating a search result matching to the keywords;
a displaying step of displaying the web log analysis information and the created search result on the user terminal; and
an attribute updating step of updating and storing attributes of the contents based on the web log analysis information and the search result.

6. The method according to claim 5, wherein the displaying step further comprises:
a report screen creating step of creating a report screen by inserting the web log analysis information and the search result into a certain template.

7. The method according to claim 6, wherein the report screen is outputted on a dashboard where the web log analysis information and the search result are collectively displayed.

8. The method according to claim 5, wherein web log analyzing/creating step extracts and analyzes scripts inserted in the service page or the contents, and creates the web log analysis information for the service page or the contents.
